(19) United States
(12) Patent Application Publication
(10) Pub. No.: US 2025/0104661 A1
(43) Pub. Date: Mar. 27, 2025

(54) DISPLAY DEVICE

(71) Applicant: Innolux Corporation, Miaoli County (TW)

(72) Inventors: Kuan-Feng Lee, Miaoli County (TW); Tsung-Han Tsai, Miaoli County (TW); Hsiao-Lang Lin, Miaoli County (TW)

(73) Assignee: Innolux Corporation, Miaoli County (TW)

(21) Appl. No.: 18/809,357

(22) Filed: Aug. 20, 2024

(30) Foreign Application Priority Data
Sep. 21, 2023 (CN) 202311225547.7

(51) Int. Cl. G09G 3/34; G02F 1/167; G02F 1/1685; G09G 3/32

(52) U.S. Cl. CPC G09G 3/344; G02F 1/167; G02F 1/1685; G09G 3/32; G09G 2320/068

(57) ABSTRACT

A display device includes a substrate, a circuit layer, a display unit, and a reflectance control unit. The circuit layer is disposed on the substrate. The display unit is disposed on the substrate and electrically connected to the circuit layer. The reflectance control unit is disposed on the substrate and electrically connected to the circuit layer. The display unit and the reflectance control unit are disposed on the same side of the substrate.

### CROSS-REFERENCE TO RELATED APPLICATION

This application claims the priority benefit of China application serial no. 202311225547.7, filed on Sep. 21, 2023. The entirety of the above-mentioned patent application is hereby incorporated by reference herein and made a part of this specification.

### BACKGROUND

### Technical Field

The disclosure relates to an electronic device, and particularly relates to a display device.

### Description of Related Art

The technology of displays has gradually developed to be mature, but there is still room for improvement. For example, the existing displays cannot provide multiple display modes (such as a reflective display mode and a light-emitting display mode) on the same side, and the existing displays require an external viewing angle optical film to achieve the function of switching the viewing angle.

### SUMMARY

The disclosure provides a display device that is capable of providing multiple display modes on the same side or controlling a viewing angle without an external viewing angle optical film.

According to an embodiment of the disclosure, a display device includes a substrate, a circuit layer, a display unit, and a reflectance control unit. The circuit layer is disposed on the substrate. The display unit is disposed on the substrate and electrically connected to the circuit layer. The reflectance control unit is disposed on the substrate and electrically connected to the circuit layer. The display unit and the reflectance control unit are disposed on the same side of the substrate.

To make the above-mentioned features and advantages of the disclosure easier to understand, exemplary embodiments will be described in detail hereinafter with reference to the accompanying drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A and FIG. 1B are partial top views of a display device operating in the first mode and the second mode respectively according to an embodiment of the disclosure.

FIG. 2A and FIG. 2B are cross-sectional views corresponding to the section line I-I′ in FIG. 1A and FIG. 1B respectively.

FIG. 3A and FIG. 3B are top views of the first-type transistor and the second-type transistor electrically connected to the display unit and the reflectance control unit respectively.

FIG. 4 is a partial cross-sectional view of a display device according to another embodiment of the disclosure.

FIG. 5 and FIG. 6 are partial top views of two display devices operating in the third mode respectively according to different embodiments of the disclosure.

FIG. 7 and FIG. 8 are partial cross-sectional views of two display devices operating in the fourth mode respectively according to different embodiments of the disclosure.

FIG. 9 to FIG. 19 are partial cross-sectional views of various display devices respectively according to different embodiments of the disclosure.

FIG. 20A to FIG. 20C are various partial top views of the reflectance control unit in FIG. 19 respectively.

### DETAILED DESCRIPTION OF DISCLOSED EMBODIMENTS

Reference will now be made in detail to the exemplary embodiments of the disclosure, and examples of the exemplary embodiments are illustrated in the accompanying drawings. Whenever possible, the same reference numbers are used in the drawings and descriptions to indicate the same or similar parts.

Certain terminologies throughout the description and the following claims serve to refer to specific components. As will be understood by those skilled in the art, electronic device manufacturers may denote components by different names. It is not intended to distinguish the components that differ by name but not by function. In the following specification and claims, the terminologies “including,” “comprising,” “having,” etc. are open-ended terminologies, so they should be interpreted to mean “including but not limited to . . . ”

The directional terminologies mentioned in the disclosure, such as “upper,” “lower,” “front,” “rear,” “left,” “right” and so on, are used with reference to the accompanying drawings. Therefore, the directional terminologies used are for illustrative but not restrictive purposes in the disclosure. In the accompanying drawings, each drawing shows the general features of the methods, structures and/or materials adopted in a specific embodiment. However, the drawings should not be construed as defining or limiting the scope or nature covered by the embodiments. For example, for clarity, the relative size, thickness, and position of each layer, region, and/or structure may be reduced or enlarged.

When a structure (or layer, component, substrate) is referred to as being located “on/above” another structure (or layer, component, substrate) in the disclosure, it may mean that the two structures are adjacent and directly connected, or it may mean that the two structures are adjacent but not directly connected. “Indirect connection” means that there is at least one intermediary structure (or intermediary layer, intermediary component, intermediary substrate, intermediary spacer) between the two structures, in which the lower surface of a structure is adjacent to or directly connected to the upper surface of the intermediary structure, and the upper surface of the other structure is adjacent to or directly connected to the lower surface of the intermediary structure. The intermediary structure may be a single-layer or multi-layer physical or non-physical structure, and there is no limitation. In the disclosure, when a structure is disposed “on” another structure, it may mean that the structure is “directly” on another structure, or that the structure is “indirectly” on another structure, with at least one structure sandwiched between the two structures.

The terminologies “about,” “equal,” “equivalent,” “identical,” “substantially,” or “approximately” are generally interpreted as being within 20% of a given value or range, or interpreted as being within 10%, 5%, 3%, 2%, 1%, or 0.5% of a given value or range. In addition, the terminologies “a given range is a first value to a second value” and “a given range falls within a range of a first value to a second value” means that the given range includes the first value, the second value, and other values in between.

The ordinal numbers used in the specification and claims, such as the terminologies “first,” “second,” and the like, to qualify a component do not imply or represent that the component or components are preceded with any ordinal numbers, nor do they represent the order of a certain component and another component, or the order in the manufacturing method, and are used only so as to clearly distinguish a component with one name from another component with the same name. Different terminologies may be used in the claims and the specification, and accordingly, a first component in the specification may be a second component in the claims.

The electrical connection or coupling described in this disclosure may refer to direct connection or indirect connection. In the case of direct connection, the endpoints of the components on the two circuits are directly connected or are connected to each other by a conductor segment. In the case of indirect connection, between the end points of the components on the two circuits there are switches, diodes, capacitors, inductances, other suitable components, or a combination of the above-mentioned components, but the disclosure is not limited thereto.

In the disclosure, thickness, length, and width may be measured by an optical microscope (OM), and thickness or width may be measured by a cross-sectional image in an electron microscope, but the disclosure is not limited thereto. Moreover, any two values or directions used for comparison may have certain errors. The terminologies “about,” “equal,” “equivalent,” “identical,” “substantially,” or “approximately” are generally interpreted as being within 10% of a given value or range. In addition, the terminologies “a given range is a first value to a second value” and “a given range falls within a range of a first value to a second value” means that the given range includes the first value, the second value, and other values in between. If a first direction is perpendicular to a second direction, the angle between the first direction and the second direction may be between 80 degrees and 100 degrees. If the first direction is parallel to the second direction, the angle between the first direction and the second direction may be between 0 degrees and 10 degrees.

Unless otherwise defined, all terminologies (including technical and scientific terminologies) used herein have the same meaning as commonly understood by people having ordinary skill in the art to which the disclosure belongs. It is understood that these terminologies, such as those defined in commonly used dictionaries, should be interpreted as having meanings consistent with the relevant art and the background or context of the disclosure, and should not be interpreted in an idealized or overly formal way, unless otherwise defined in the embodiments of the disclosure.

The electronic device disclosed in the specification may include a display device, a backlight device, an antenna device, a sensing device, or a tiled device, but is not limited thereto. The electronic device may be a bendable or flexible electronic device. The display device may be a non-self-luminous display device or a self-luminous display device. The electronic device may include, for example, liquid crystal, light-emitting diode, fluorescence, phosphor, quantum dot (QD), other suitable display media, or a combination of the foregoing. The antenna device may include, for example, a frequency selective surface (FSS), a RF-filter, a polarizer, a resonator, or an antenna. The antenna may be a liquid crystal antenna or a non-liquid crystal antenna, and the sensing device may be a sensing device for sensing capacitance, light, heat, or ultrasonic waves, but is not limited thereto. In the disclosure, the electronic device may include electronic components. The electronic components may include passive components and active components, such as capacitors, resistors, inductors, diodes, transistors, and the like. The diodes may include light-emitting diodes or photodiodes. The light-emitting diodes may include, for example, organic light-emitting diodes (OLED), sub-millimeter light-emitting diodes (mini LED), micro light-emitting diodes (micro LED), or quantum dot light-emitting diodes (quantum dot LED), but is not limited thereto. The tiled device may be, for example, a display tiled device or an antenna tiled device, but is not limited thereto. It should be noted that the electronic device may be any arrangement and combination of the foregoing, but not limited to thereto. In addition, the appearance of the electronic device may be rectangular, circular, polygonal, in a shape with curved edges, or in other suitable shapes. The electronic device may have peripheral systems such as a driving system, a control system, a light source system, and the like, so as to support a display device, an antenna device, a wearable device (e.g., including glasses or watch), an in-vehicle device (e.g., including car windshield or decoration that blends into the environment), or a tiled device.

Note that in the following embodiments, the technical features provided in several different embodiments may be replaced, reorganized, and mixed without departing from the spirit of the disclosure so as to complete other embodiments. The technical features of the embodiments may be mixed and matched arbitrarily as long as they do not violate the spirit of the disclosure or conflict with each other.

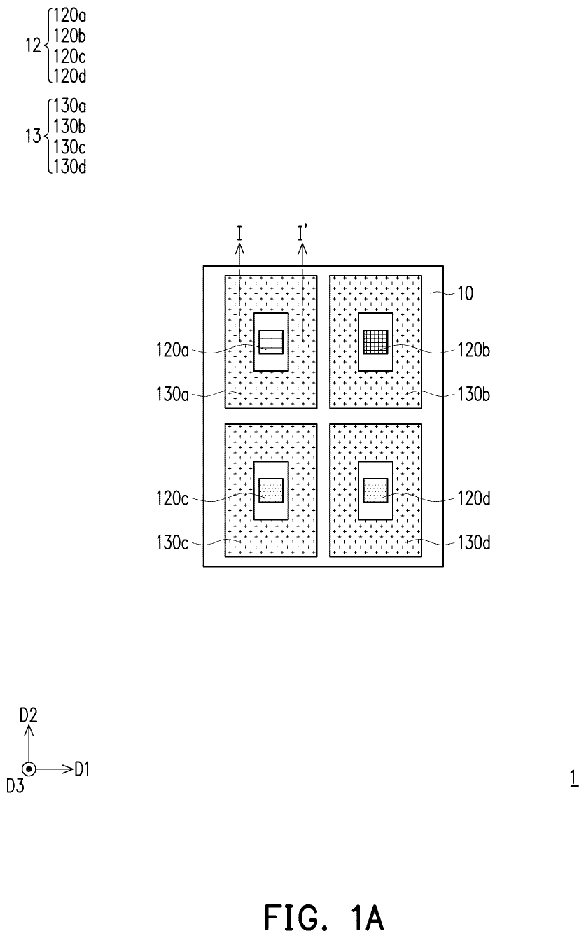

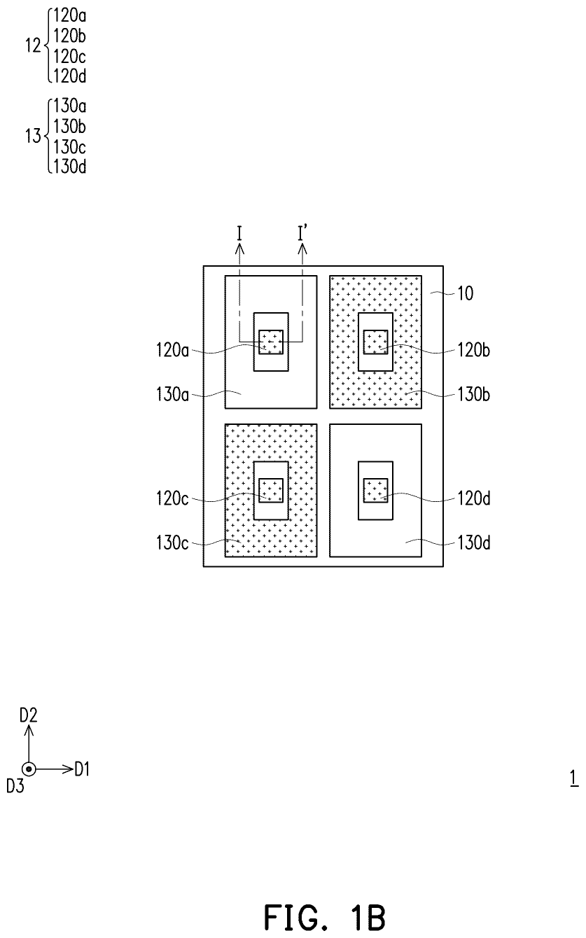

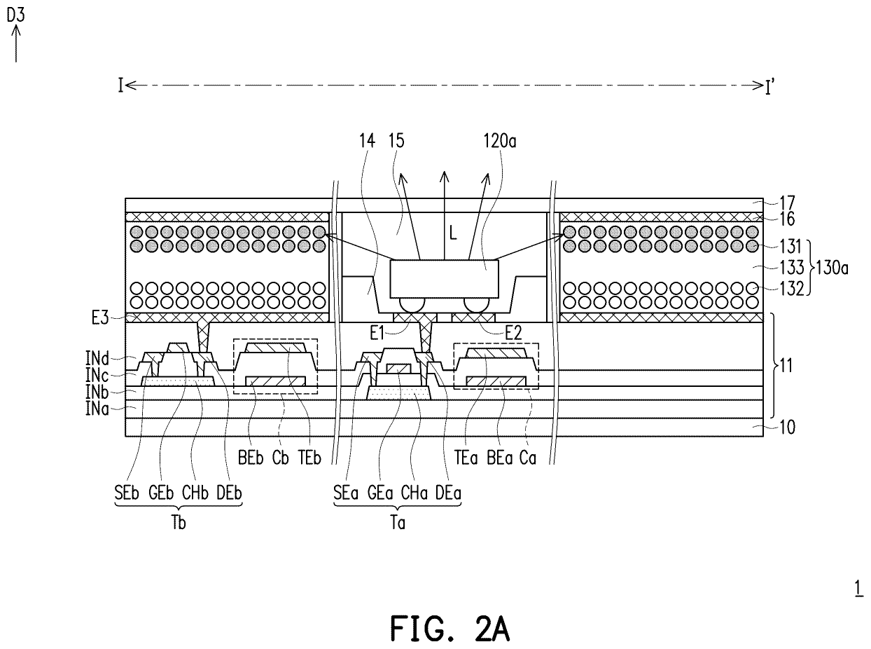

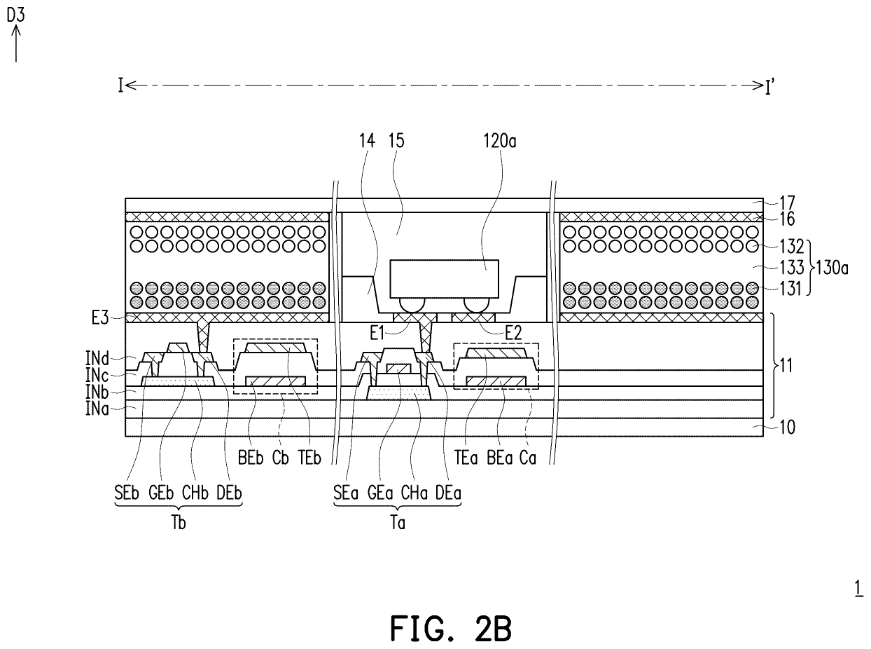

FIG. 1A and FIG. 1B are partial top views of a display device operating in a first mode and a second mode respectively according to an embodiment of the disclosure. FIG. 2A and FIG. 2B are cross-sectional views corresponding to the section line I-I′ in FIG. 1A and FIG. 1B respectively.

First, referring to FIG. 1A and FIG. 2A, a display device 1 includes a substrate 10, a circuit layer 11, a display unit 12, and a reflectance control unit 13. The circuit layer 11 is disposed on the substrate 10. The display unit 12 is disposed on the substrate 10 and is electrically connected to the circuit layer 11. The reflectance control unit 13 is disposed on the substrate 10 and is electrically connected to the circuit layer 11. The display unit 12 and the reflectance control unit 13 are disposed on the same side of the substrate 10 (for example, the upper side of the substrate 10).

In detail, the substrate 10 may be a rigid substrate or a flexible substrate. The material of the substrate 10 includes, for example, glass, quartz, ceramics, sapphire, or plastics, but not limited thereto. The plastics may include polycarbonate (PC), polyimide (PI), polypropylene (PP), polyethylene terephthalate (PET), other suitable flexible materials, or a combination of the aforementioned materials, but not limited thereto. In addition, the light transmittance of the substrate 10 is not particularly limited. That is to say, the substrate 10 may be a light-transmissive substrate, a semi-light-transmissive substrate, or an opaque substrate.

The circuit layer 11 is, for example, disposed between the display unit 12 and the substrate 10 and between the reflectance control unit 13 and the substrate 10. In some embodiments, the circuit layer 11 may include a first-type transistor Ta electrically connected to the display unit 12 and a second-type transistor Tb electrically connected to the reflectance control unit 13. The first-type transistor Ta includes, for example, a gate electrode GEa, a semiconductor pattern CHa, a source electrode SEa, and a drain electrode DEa; and the second-type transistor Tb includes, for example, a gate electrode GEb, a semiconductor pattern CHb, a source electrode SEb, and a drain electrode DEb, but not limited thereto.

The materials of the gate electrode GEa, the gate electrode GEb, the source electrode SEa, the source electrode SEb, the drain electrode DEa, and the drain electrode DEb may include metal or a metal stack, such as aluminum, molybdenum, or titanium/aluminum/titanium, but not limited thereto. The materials of the semiconductor pattern CHa and the semiconductor pattern CHb include, for example, a silicon semiconductor, an oxide semiconductor, or other suitable semiconductor materials. The silicon semiconductor includes, for example, amorphous silicon or polycrystalline silicon. The oxide semiconductor includes, for example, indium tin oxide (ITO), indium zinc oxide (IZO), indium gallium oxide (IGO), or indium gallium zinc oxide (IGZO), but not limited thereto.

The materials of the semiconductor pattern CHa and the semiconductor pattern CHb may be different. Specifically, the material of the semiconductor pattern may be selected according to the actual applications (for example, based on considerations such as driving current, driving voltage, driving frequency, or voltage stability). For example, for applications involving a high driving current, the material of the semiconductor pattern may be a silicon semiconductor. Further, for applications involving a high driving voltage and/or high stability (low leakage), the material of the semiconductor pattern may be an oxide semiconductor, but not limited thereto. In some embodiments, the semiconductor pattern CHa and the semiconductor pattern CHb may be made of a silicon semiconductor and an oxide semiconductor respectively. That is to say, the first-type transistor Ta includes a silicon semiconductor, and the second-type transistor Tb includes an oxide semiconductor, but not limited thereto.

According to different requirements, the circuit layer 11 may further include other film layers and/or components. Taking FIG. 2A as an example, the circuit layer 11 may further include a plurality of dielectric layers (such as a dielectric layer INa, a dielectric layer INb, a dielectric layer Inc, and a dielectric layer INd), a plurality of storage capacitors (a storage capacitor Ca and a storage capacitor Cb), and a plurality of electrodes (such as an electrode E1, an electrode E2, and an electrode E3).

The materials of the dielectric layer INa, the dielectric layer INb, the dielectric layer INc, and the dielectric layer INd include, for example, an organic insulating material, an inorganic insulating material, or a combination of the aforementioned materials. The organic insulating material includes, for example, polymethyl methacrylate (PMMA), epoxy resin (epoxy), acrylic-based resin, silicone, polyimide polymer, or a combination of the aforementioned materials, but not limited thereto. The inorganic insulating material includes, for example, silicon oxide, silicon nitride, or silicon oxynitride, but not limited thereto. In some embodiments, the materials of the dielectric layer INa, the dielectric layer INb, and the dielectric layer INc are selected from inorganic insulating materials, and the material of the dielectric layer INd is selected from organic insulating materials, for example, but not limited thereto.

The storage capacitor Ca is composed of, for example, a lower electrode BEa, the dielectric layer INc, and an upper electrode TEa; and the storage capacitor Cb is composed of, for example, a lower electrode BEb, the dielectric layer INc, and an upper electrode TEb. The materials of the lower electrode BEa, the lower electrode BEb, the upper electrode TEa, and the upper electrode TEb may include metal or a metal stack, such as aluminum, molybdenum, or titanium/aluminum/titanium, but not limited thereto.

The materials of the electrode E1, the electrode E2, and the electrode E3 may include a transparent conductive material or an opaque conductive material. The transparent conductive material includes, for example, metal oxide, graphene, other suitable transparent conductive materials, or a combination of the aforementioned materials, but not limited thereto. The metal oxide includes, for example, indium tin oxide, indium zinc oxide, aluminum tin oxide, aluminum zinc oxide, indium germanium zinc oxide, or other metal oxides. The opaque conductive material includes, for example, metal, alloy, or a combination of the aforementioned, but not limited thereto.

As shown in FIG. 2A, the dielectric layer INa may be disposed on the substrate 10. The semiconductor pattern CHa may be disposed on the dielectric layer INa. The dielectric layer INb may be disposed on the semiconductor pattern CHa and the dielectric layer INa. The semiconductor pattern CHb, the gate electrode GEa, the lower electrode BEa, and the lower electrode BEb may be disposed on the dielectric layer INb, wherein the gate electrode GEa overlaps the semiconductor pattern CHa in the direction D3. The dielectric layer INc may be disposed on the dielectric layer INb, the semiconductor pattern CHb, the gate electrode GEa, the lower electrode BEa, and the lower electrode BEb. The gate electrode GEb, the source electrode SEa, the drain electrode DEa, the source electrode SEb, the drain electrode DEb, the upper electrode TEa, and the upper electrode TEb may be disposed on the dielectric layer INc, wherein the gate electrode GEb overlaps the semiconductor pattern CHb in the direction D3. Each of the source electrode SEa and the drain electrode DEa penetrates the dielectric layer INb and the dielectric layer INc and is electrically connected to the semiconductor pattern Cha. Each of the source electrode SEb and the drain electrode DEb penetrates the dielectric layer INc and is electrically connected to the semiconductor pattern CHb. The upper electrode TEa overlaps the lower electrode BEa in the direction D3, and the upper electrode TEb overlaps the lower electrode BEb in the direction D3. The dielectric layer INd may be disposed on the dielectric layer INc, the gate electrode GEb, the source electrode SEa, the drain electrode DEa, the source electrode SEb, the drain electrode DEb, the upper electrode TEa, and the upper electrode TEb. The electrode E1, the electrode E2, and the electrode E3 may be disposed on the dielectric layer INd, wherein the electrode E1 penetrates the dielectric layer INd and is electrically connected to the drain electrode DEa, and the electrode E3 penetrates the dielectric layer INd and is electrically connected to the drain electrode DEb.

The display unit 12 and the reflectance control unit 13 are jointly disposed on the circuit layer 11, and the display unit 12 and the reflectance control unit 13 are, for example, configured to respectively display a first image and a second image toward the same direction (for example, the direction D3). In other words, the user can see the first image displayed by the display unit 12 and the second image displayed by the reflectance control unit 13 from the same side of the display device 1. Here, the first image and the second image respectively refer to the image displayed by the display unit 12 and the image displayed by the reflectance control unit 13. In some embodiments, the first image and the second image may display the same or different patterns and/or text. In some embodiments, the first image and the second image may have different display effects (for example, different colors or different resolutions). In some embodiments, the first image and the second image may be displayed at the same time or not at the same time.

In detail, the display unit 12 and the reflectance control unit 13 may display images in different manners. For example, the display unit 12 may display the first image by emitting a light, and the reflectance control unit 13 may display the second image by reflecting or absorbing an incident light from the outside. Under this architecture, the color of the first image may be determined by the light-emitting elements, color conversion elements and/or filter elements in the display unit 12. In contrast thereto, the color of the second image may be determined by the colors of the light-absorbing particles and light-reflective particles in the reflectance control unit 13.

Taking FIG. 1A to FIG. 2B as an example, the display unit 12 may include a plurality of light-emitting elements (such as a light-emitting element 120a, a light-emitting element 120b, a light-emitting element 120c, and a light-emitting element 120d) that emit lights to display an image. The light-emitting elements include, for example, a plurality of light-emitting diodes (LED), a plurality of organic light-emitting diodes (OLED), a plurality of sub-millimeter light-emitting diodes (mini LED), a plurality of micro light-emitting diodes (micro LED), or a plurality of quantum dot light-emitting diodes (quantum dot LED), but not limited thereto. The light-emitting elements may be arranged in an array in the direction D1 and the direction D2 to display the first image. In some embodiments, as shown in FIG. 1A, the light-emitting elements may include a plurality of light-emitting elements of different colors. For example, the light-emitting element 120a, the light-emitting element 120b, the light-emitting element 120c, and the light-emitting element 120d may be a red light-emitting element, a green light-emitting element, a blue light-emitting element, and a yellow light-emitting element respectively, but not limited thereto. By arranging light-emitting elements of multiple colors, the first image displayed by the display unit 12 may be a colored image.

The reflectance control unit 13 may include a plurality of reflectance control elements (such as a reflectance control element 130a, a reflectance control element 130b, a reflectance control element 130c, and a reflectance control element 130d), wherein each of the reflectance control elements may include a plurality of electrophoretic particles that display an image by reflecting or absorbing an incident light from the outside.

The color of the electrophoretic particles may be selected according to actual requirements. Black electrophoretic particles may be used to absorb lights of various colors. When a plurality of black electrophoretic particles are distributed on the display side of the display device 1, the reflectance control elements present a black screen. White electrophoretic particles may be used to reflect lights of various colors. When a plurality of white electrophoretic particles are distributed on the display side of the display device 1, the reflectance control elements present a screen of the color of the incident light. For example, when the incident light is sunlight or a white light, the reflectance control elements present a white screen. Colored electrophoretic particles may be used to reflect a light of the corresponding color. For example, red electrophoretic particles may be used to reflect a red light, green electrophoretic particles may be used to reflect a green light, blue electrophoretic particles may be used to reflect a blue light, and so on. When a plurality of colored electrophoretic particles are distributed on the display side of the display device 1, the reflectance control elements present the corresponding color. For example, when a plurality of red electrophoretic particles are distributed on the display side of the display device 1, the reflectance control elements present red, and so on.

A plurality of reflectance control elements may be arranged in an array in the direction D1 and the direction D2 to display the second image. In some embodiments, each of the reflectance control elements may include a plurality of black electrophoretic particles and a plurality of white electrophoretic particles, so that the second image displayed by the reflectance control unit 13 may be a black and white image. In some embodiments, each of the reflectance control elements may include a plurality of black electrophoretic particles and a plurality of colored electrophoretic particles, so that the second image may be a colored image. For example, the reflectance control element 130a may include a plurality of black electrophoretic particles and a plurality of red electrophoretic particles, the reflectance control element 130b may include a plurality of black electrophoretic particles and a plurality of green electrophoretic particles, the reflectance control element 130c may include a plurality of black electrophoretic particles and a plurality of blue electrophoretic particles, and the reflectance control element 130d may include a plurality of black electrophoretic particles and a plurality of yellow electrophoretic particles, but not limited thereto.

Taking FIG. 2A as an example, each of the reflectance control elements may include a plurality of electrophoretic particles 131, a plurality of electrophoretic particles 132, and a solution 133 (such as a transparent solution), wherein the electrophoretic particles 131 and the electrophoretic particles 132 are suspended in the solution 133. The electrophoretic particles 131 and the electrophoretic particles 132 carry opposite charges. For example, the electrophoretic particles 131 are black electrophoretic particles and are negatively charged, and the electrophoretic particles 132 are white electrophoretic particles or colored electrophoretic particles and are positively charged. Under the action of an external electric field, the negatively charged electrophoretic particles 131 move toward the positively charged electrode, and the positively charged electrophoretic particles 132 move toward the negatively charged electrode, causing the electrophoretic particles 131 and the electrophoretic particles 132 to be respectively distributed in different areas of the reflectance control element. By changing the voltage applied to a plurality of electrodes adjacent to the reflectance control element, the distribution of a plurality of electrophoretic particles (including the electrophoretic particles 131 and the electrophoretic particles 132) may be controlled, thereby controlling the color (for example, black, white, or other colors) displayed by the reflectance control element.

In some embodiments, in a top view (see FIG. 1A or FIG. 1B), at least one of the light-emitting elements may be surrounded by one of the reflectance control elements. For example, the light-emitting element 120a may be surrounded by the reflectance control element 130a, the light-emitting element 120b may be surrounded by the reflectance control element 130b, the light-emitting element 120c may be surrounded by the reflectance control element 130c, and the light-emitting element 120d may be surrounded by the reflectance control element 130d. In this specification, a first element being surrounded by a second element means that the second element is located around the first element, wherein the second element may surround the first element continuously or discontinuously. In some embodiments, the resolution of the light-emitting elements may be greater than or equal to the resolution of the reflectance control elements. The resolution is defined as the number of elements per unit area. In some embodiments, in a top view, the area occupied by the display unit 12 may be smaller than the area occupied by the reflectance control unit 13.

According to different requirements, the display device 1 may further include other components or film layers. Taking FIG. 2A as an example, the display device 1 may further include a spacer layer (also called a pixel definition layer) 14, an interposer layer 15, a common electrode 16, and an encapsulation layer 17, but not limited thereto. The spacer layer 14 is disposed on the dielectric layer INd and may expose the electrode E1, the electrode E2, and the electrode E3 for the light-emitting element (the light-emitting element 120a is schematically shown in FIG. 2A) to be electrically connected to the circuit layer 11 through the electrode E1 and the electrode E2 and for the electrode E3 disposed under the reflectance control element (the reflectance control element 130a is schematically shown in FIG. 2A) to be electrically connected to the circuit layer 11. The material of the spacer layer includes, for example, an opaque organic polymer material so as to reduce problems such as interference and/or light mixing between adjacent light-emitting elements. The opaque organic polymer material may be a white, gray, or black organic polymer material, such as a black matrix, but not limited thereto. In some embodiments, the material of the spacer layer may include a transparent organic polymer material. The transparent organic polymer material may include resin, but not limited thereto.

The interposer layer 15 is disposed on the spacer layer 14, the light-emitting elements, the electrode E1, and the electrode E2. According to different requirements, the interposer layer 15 may be a filling layer, an optical layer, or a lens layer, but not limited thereto. The material of the interposer layer 15 includes, for example, optical clear adhesive (OCA) or optical clear resin (OCR), but not limited thereto.

The common electrode 16 is disposed on the reflectance control element (the reflectance control element 130a is schematically shown in FIG. 2A), and the reflectance control element (the reflectance control element 130a is schematically shown in FIG. 2A) is located between the electrode E3 and the common electrode 16. The material of the common electrode 16 includes, for example, a transparent conductive material, such as indium tin oxide (ITO), indium zinc oxide (IZO), indium gallium zinc oxide (IGZO), or magnesium silver alloy (MgAg alloy), but not limited thereto.

The encapsulation layer 17 is disposed on the common electrode 16 and the interposer layer 15. The material of the encapsulation layer 17 includes, for example, silicon oxide, silicon nitride, silicon oxynitride, or an acrylic polymer material, but not limited thereto.

The display device 1 is capable of operating in a first mode (see FIG. 1A and FIG. 2A) and a second mode (see FIG. 1B and FIG. 2B), for example. When the display device 1 operates in the first mode, the display unit 12 displays the first image; and when the display device 1 operates in the second mode, the reflectance control unit 13 displays the second image.

In detail, as shown in FIG. 1A and FIG. 2A, when the display device 1 operates in the first mode, at least one of the light-emitting elements in the display unit 12 emits a light L, and the reflectance control unit 13 absorbs an ambient light to display the first image. For example, a voltage difference may be provided between the electrode E1 and the electrode E2, enabling at least one of the light-emitting elements to emit the light L. Furthermore, by applying a positive voltage to the common electrode 16 and a negative voltage to the electrode E3, the principle of positive and negative attraction causes a plurality of electrophoretic particles 131 (for example, a plurality of negatively charged black electrophoretic particles) to be distributed on the display side of the display device 1 (the same side as the light-emitting side of the light-emitting element, such as the upper side of the reflectance control element 130a) and causes a plurality of electrophoretic particles 132 (for example, a plurality of positively charged white electrophoretic particles or a plurality of colored electrophoretic particles) to be distributed on the non-display side of the display device 1 (the side opposite to the light-emitting side of the light-emitting element, such as the lower side of the reflectance control element 130a). By distributing a plurality of negatively charged black electrophoretic particles on the display side of the display device 1, the black electrophoretic particles are allowed to absorb the ambient light and help reduce the interference of reflection of the ambient light on the display screen. Further, the black electrophoretic particles may also absorb a large-angle light from the light-emitting element (the light-emitting element 120a is schematically shown in FIG. 2A) and provide the effect of limiting the viewing angle or preventing peeping. The electrophoretic particles and the light-emitting element may have different driving voltages and/or driving frequencies. For example, the driving voltage of the electrophoretic particles may be 15V to 70V, and the driving voltage of the light-emitting element may be 3V to 10V; the driving frequency of the electrophoretic particles may be 50 Hz, and the driving frequency of the light-emitting element may be 60 Hz to 240 Hz, but not limited thereto. In addition, the driving waveforms of the electrophoretic particles and the light-emitting element are not particularly limited. For example, the driving waveforms of the electrophoretic particles and the light-emitting element may be a square wave, a sine wave, or a pulse wave, but not limited thereto.

On the other hand, as shown in FIG. 1B and FIG. 2B, when the display device 1 operates in the second mode, the display unit 12 may be turned off, and at least a part of the reflectance control elements is enabled to reflect light to display the second image. In some embodiments, as shown in FIG. 1B and FIG. 2B, when the display device 1 operates in the second mode, a part of the reflectance control elements (such as the reflectance control element 130a and the reflectance control element 130d) may reflect light, and another part of the reflectance control elements (such as the reflectance control element 130b and the reflectance control element 130c) may absorb the ambient light. For example, no voltage difference is provided between the electrode E1 and the electrode E2, so that the light-emitting elements do not emit a light. Furthermore, by applying a negative voltage to the common electrode 16 and a positive voltage to the electrode E3, the principle of positive and negative attraction causes a plurality of electrophoretic particles 132 (for example, a plurality of positively charged white electrophoretic particles or a plurality of colored electrophoretic particles) to be distributed on the display side of the display device 1 (the same side as the light-emitting side of the light-emitting element, such as the upper side of the reflectance control element 130a) and causes a plurality of electrophoretic particles 131 (for example, a plurality of negatively charged black electrophoretic particles) to be distributed on the non-display side of the display device 1 (the side opposite to the light-emitting side of the light-emitting element, such as the lower side of the reflectance control element 130a). By distributing a plurality of positively charged white electrophoretic particles or a plurality of colored electrophoretic particles on the display side of the display device 1, the reflectance control element is enabled to present a corresponding color. Further, by controlling the color (such as black, white, or other colors) displayed by each of the reflectance control elements distributed in an array, the display device 1 is capable of providing corresponding information such as images or text.

Taking FIG. 1B as an example, the distribution of the electrophoretic particles in the reflectance control element 130a and the reflectance control element 130d is shown in FIG. 2B, and the distribution of the electrophoretic particles in the reflectance control element 130b and the reflectance control element 130c is shown in FIG. 2A. In the case where the electrophoretic particles 131 in each reflectance control element in FIG. 1B are all black electrophoretic particles and the electrophoretic particles 132 are all white electrophoretic particles, when the display device 1 operates in the second mode, the reflectance control unit 13 displays a black and white image. Further, in the case where the electrophoretic particles 131 in each reflectance control element in FIG. 1B are all black electrophoretic particles and the electrophoretic particles 132 are all colored electrophoretic particles, when the display device 1 operates in the second mode, the reflectance control unit 13 displays a colored image. For example, when the display device 1 operates in the second mode, a first part of the reflectance control elements (such as the reflectance control element 130a) reflects a first light (such as a red light), a second part of the reflectance control elements (such as the reflectance control element 130d) reflects a second light (such as a yellow light), and the colors of the first light and the second light are different. When the display device 1 operates in the second mode, the reflectance control unit has an effect of displaying a static image without consuming energy, making it suitable as decoration in indoor spaces for displaying static images according to different requirements.

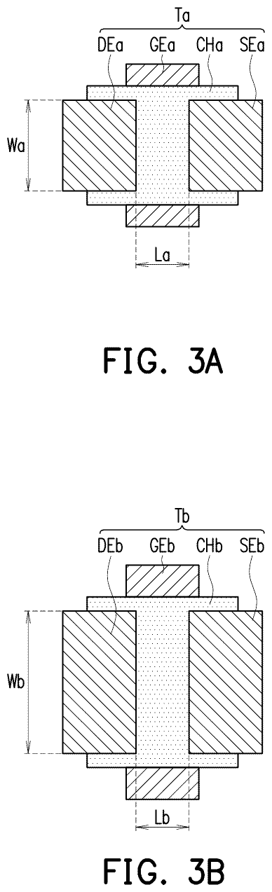

In some embodiments, the channel width and/or the channel length of the transistor (such as the first-type transistor Ta and the second-type transistor Tb) may be determined according to the power required. For example, the power required by the electrophoretic particles (such as driving voltage) is greater than the power required by the light-emitting element. Therefore, the power of the second-type transistor Tb may be increased by increasing the channel width of the second-type transistor Tb and/or decreasing the channel length of the second-type transistor Tb. FIG. 3A and FIG. 3B are top views of the first-type transistor and the second-type transistor electrically connected to the display unit and the reflectance control unit respectively. Referring to FIG. 3A and FIG. 3B, the first-type transistor Ta has a first channel width Wa and a first channel length La, the second-type transistor Tb has a second channel width Wb and a second channel length Lb, and the ratio of the first channel width Wa to the first channel length La (that is, Wa/La) is smaller than the ratio of the second channel width Wb to the second channel length Lb (that is, Wb/Lb). For example, the second channel width Wb may be greater than the first channel width Wa, and the second channel length Lb may be smaller than or equal to the first channel length La.

In some embodiments, the number of transistors and/or the number of storage capacitors corresponding to the display unit 12 and the reflectance control unit 13 may also be changed according to different requirements. For example, the number of transistors corresponding to the display unit 12 may be greater than or equal to the number of transistors corresponding to the reflectance control unit 13, and/or the number of storage capacitors corresponding to the display unit 12 may be greater than the number of storage capacitors corresponding to the reflectance control unit 13, but not limited thereto. In some embodiments, each light-emitting element may correspond to six transistors and two storage capacitors, seven transistors and two storage capacitors, or other configurations. In some embodiments, each reflectance control element may correspond to one transistor and zero or one storage capacitor, three transistors and zero or one storage capacitor, or other configurations.

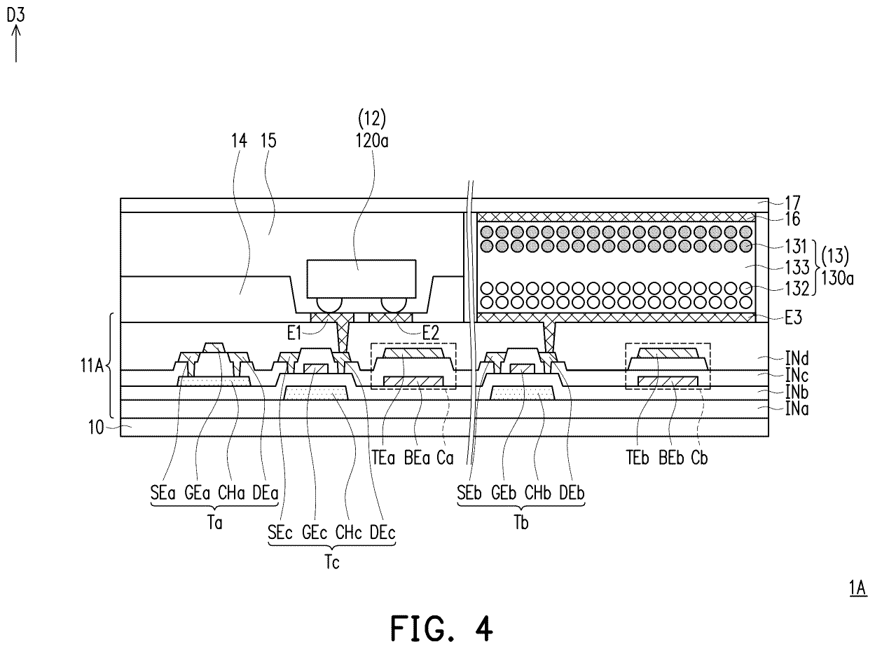

FIG. 4 is a partial cross-sectional view of a display device according to another embodiment of the disclosure. Referring to FIG. 4, in a display device 1A, a circuit layer 11A may also include a second-type transistor Tc electrically connected to the display unit 12, wherein the second-type transistor Tc includes, for example, a gate electrode GEc, a semiconductor pattern CHc, a source electrode Sec, and a drain electrode DEc. The second-type transistor Tc may use the same material as the semiconductor pattern CHb of the second-type transistor Tb, such as an oxide semiconductor, to improve the power saving. The arrangement relationship of the gate electrode GEc, the semiconductor pattern CHc, the source electrode Sec, and the drain electrode DEc in the second-type transistor Tc relative to other film layers may be understood from the description of the second-type transistor Tb and will not be repeated here.

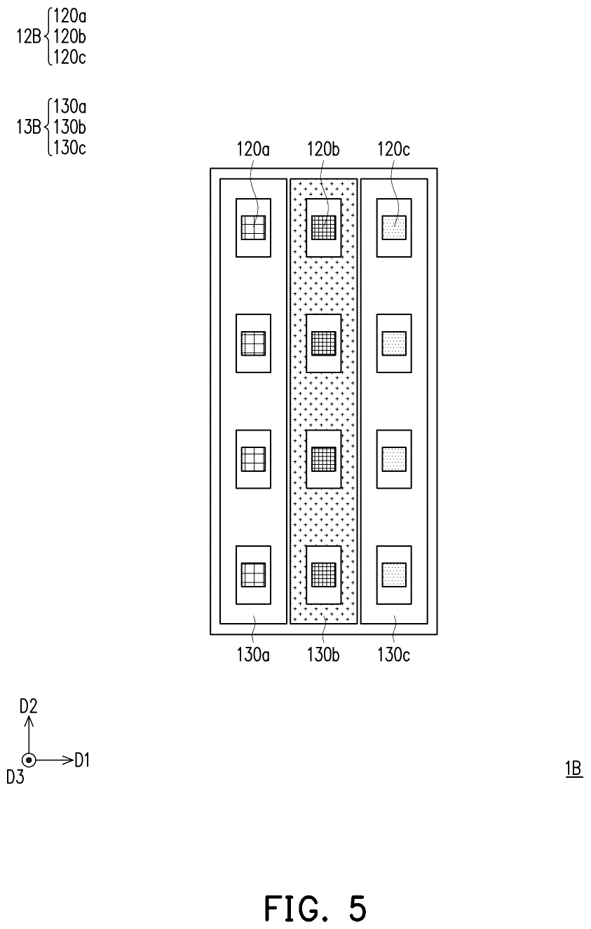

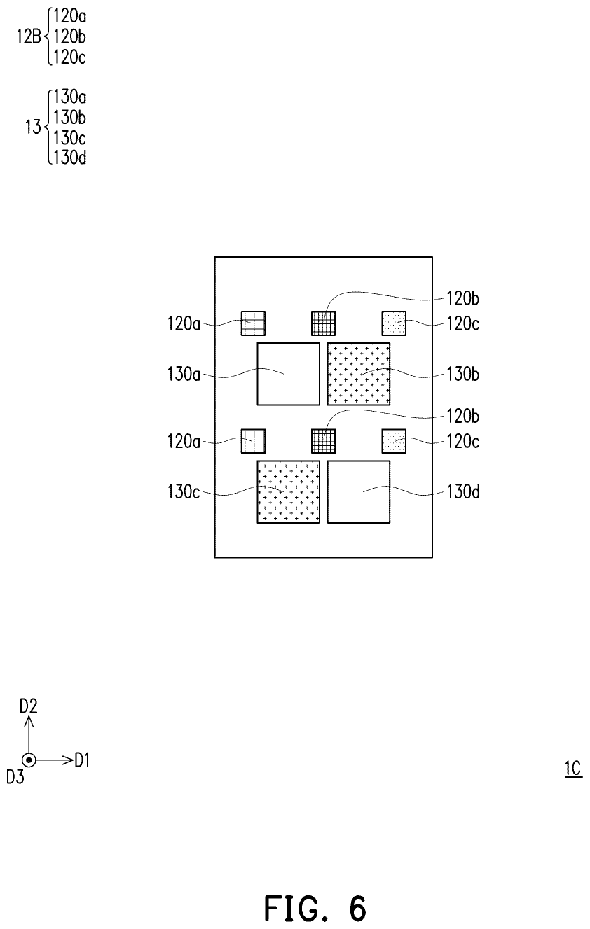

In some embodiments, in addition to the first mode and the second mode, the display device may also have a third mode. When the display device operates in the third mode, the display unit and the reflectance control unit display different images. FIG. 5 and FIG. 6 are partial top views of two display devices operating in the third mode respectively according to different embodiments of the disclosure.

Referring to FIG. 5, in a display device 1B, a display unit 12B includes, for example, a plurality of light-emitting elements 120a, a plurality of light-emitting elements 120b, and a plurality of light-emitting elements 120c. A reflectance control unit 13B includes, for example, a plurality of reflectance control elements 130a (one is schematically shown), a plurality of reflectance control elements 130b (one is schematically shown), and a plurality of reflectance control elements 130c (one is schematically shown). The light-emitting elements 120a, the light-emitting elements 120b, and the light-emitting elements 120c may respectively be a plurality of red light-emitting elements, a plurality of green light-emitting elements, and a plurality of blue light-emitting elements, but not limited thereto. Each of the reflectance control elements may include a plurality of black electrophoretic particles and a plurality of white electrophoretic particles; or each of the reflectance control elements may include a plurality of black electrophoretic particles and a plurality of colored electrophoretic particles. For example, the reflectance control element 130a may include a plurality of black electrophoretic particles and a plurality of red electrophoretic particles, the reflectance control element 130b may include a plurality of black electrophoretic particles and a plurality of green electrophoretic particles, and the reflectance control element 130c may include a plurality of black electrophoretic particles and a plurality of blue electrophoretic particles, but not limited thereto.

Each reflectance control element 130a surrounds, for example, a plurality of light-emitting elements 120a arranged in the direction D2. Each reflectance control element 130b surrounds, for example, a plurality of light-emitting elements 120b arranged in the direction D2. Each reflectance control element 130c surrounds, for example, a plurality of light-emitting elements 120c arranged in the direction D2. When the display device 1B operates in the third mode, at least some of the light-emitting elements in the display unit 12B may be turned on, and at least some of the reflectance control elements (such as the reflectance control element 130a and the reflectance control element 130c) in the reflectance control unit 13B may reflect light, for example, reflect a white light or other colored lights, depending on the color of the electrophoretic particles (electrophoretic particles 132 in FIG. 2B).

Referring to FIG. 6, in a display device 1C, a display unit 12B includes, for example, a plurality of light-emitting elements 120a, a plurality of light-emitting elements 120b, and a plurality of light-emitting elements 120c. A reflectance control unit 13 includes, for example, a plurality of reflectance control elements 130a (one is schematically shown), a plurality of reflectance control elements 130b (one is schematically shown), a plurality of reflectance control elements 130c (one is schematically shown), and a plurality of reflectance control elements 130d. The light-emitting elements 120a, the light-emitting elements 120b, and the light-emitting elements 120c may respectively be a plurality of red light-emitting elements, a plurality of green light-emitting elements, and a plurality of blue light-emitting elements, but not limited thereto. Each of the reflectance control elements may include a plurality of black electrophoretic particles and a plurality of white electrophoretic particles; or each of the reflectance control elements may include a plurality of black electrophoretic particles and a plurality of colored electrophoretic particles. For example, the reflectance control element 130a may include a plurality of black electrophoretic particles and a plurality of red electrophoretic particles, the reflectance control element 130b may include a plurality of black electrophoretic particles and a plurality of green electrophoretic particles, the reflectance control element 130c may include a plurality of black electrophoretic particles and a plurality of blue electrophoretic particles, and the reflectance control element 130d may include a plurality of black electrophoretic particles and a plurality of yellow electrophoretic particles, but not limited thereto. When the display device operates in the third mode, one of the scenarios of actually using the display device is that the reflectance control unit 13 may be used to display a static image, such as an ink painting background, and the display unit 12B may be used to display a dynamic image, such as a flowing river or a moving boat or bird. In such a scenario, the reflectance control unit 13 displays the static image without consuming energy while the display unit 12B displays a subtle dynamic image, thereby achieving the effect of saving power consumption.

Each reflectance control element 130a (or reflectance control element 130c) is, for example, located between two light-emitting elements 120a arranged in the direction D2 and between two light-emitting elements 120b arranged in the direction D2. Each reflectance control element 130b (or reflectance control element 130d) is, for example, located between two light-emitting elements 120b arranged in the direction D2 and between two light-emitting elements 120c arranged in the direction D2. When the display device 1C operates in the third mode, at least some of the light-emitting elements in the display unit 12B may be turned on, and at least some of the reflectance control elements (such as the reflectance control element 130a and the reflectance control element 130d) in the reflectance control unit 13 may reflect light, for example, reflect a white light or other colored lights, depending on the color of the electrophoretic particles (electrophoretic particles 132 in FIG. 2B).

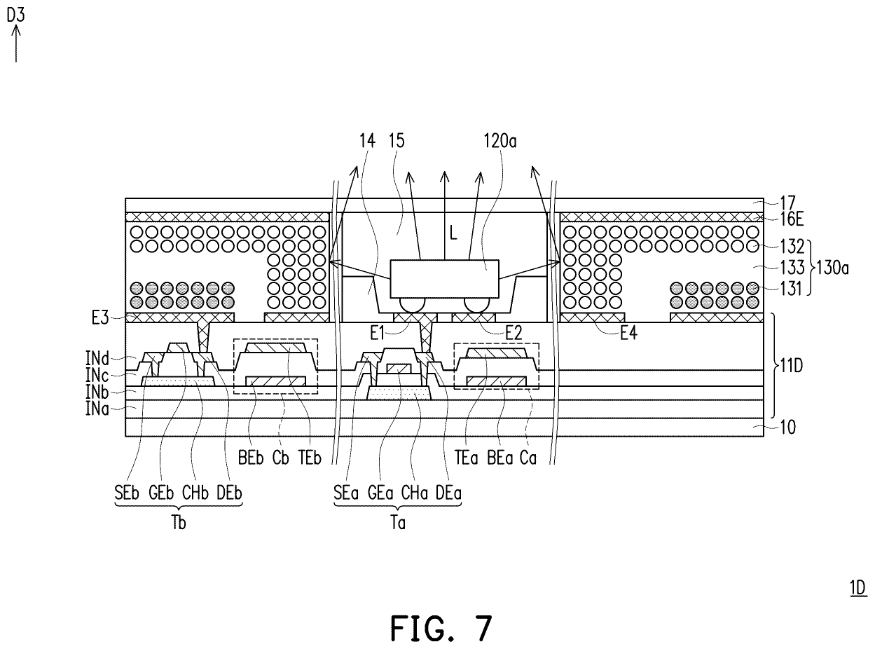

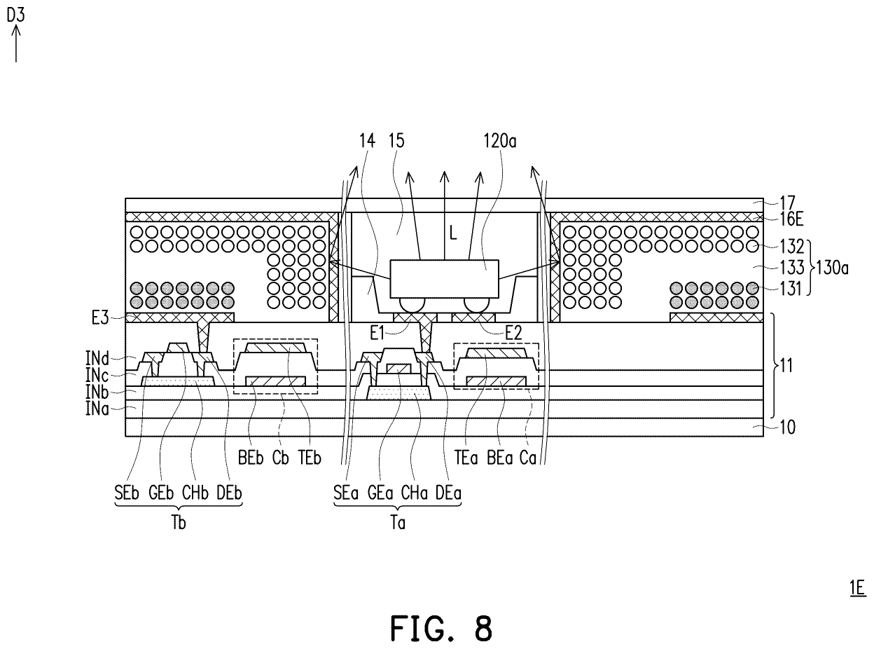

In some embodiments, in addition to the first mode, the second mode, and the third mode, the display device may further have a fourth mode. When the display device operates in the fourth mode, the display unit displays a third image, and the reflectance control unit reflects a light from the display unit. FIG. 7 and FIG. 8 are partial cross-sectional views of two display devices operating in the fourth mode respectively according to different embodiments of the disclosure.

Referring to FIG. 7, in a display device 1D, a circuit layer 11D further includes an electrode E4. The electrode E4 is disposed on the dielectric layer INd and electrically insulated from the electrode E3, wherein the electrode E4 and a common electrode 16E are respectively disposed on opposite sides (such as the upper and lower sides) of the reflectance control element (the reflectance control element 130a is schematically shown in FIG. 7). The material of the electrode E4 may be understood from the description of the material of the electrode E3 and will not be repeated here. In addition, the electrophoretic particles 131 and the electrophoretic particles 132 are, for example, a plurality of black electrophoretic particles and a plurality of white electrophoretic particles respectively.

When the display device 1D operates in the fourth mode, at least one of the light-emitting elements may emit a light L. In addition, by applying a positive voltage to the electrode E3 and a negative voltage to the common electrode 16E and the electrode E4, the principle of positive and negative attraction causes the white electrophoretic particles to be distributed on the display side of the display device 1D (such as the upper side of the reflectance control element 130a) and the sidewall of the reflectance control element adjacent to the light-emitting element (such as the light-emitting element 120a) so as to reflect a large-angle light from the light-emitting element and achieve the effect of collimating the light (or limiting the viewing angle or preventing peeping) or improving the light utilization efficiency. In some embodiments, the thickness of the sidewall of the reflectance control element may also be increased (for example, the reflectance control element 130a may be thickened) for the light L incident on the sidewall to be reflected by the white electrophoretic particles distributed adjacent to the sidewall of the light-emitting element (such as the light-emitting element 120a), thereby further limiting the viewing angle.

Referring to FIG. 8, in a display device 1E, the common electrode 16E extends from the top surface of the reflectance control element 130a to the sidewall of the reflectance control element 130a adjacent to the light-emitting element (such as the light-emitting element 120a). In addition, the electrophoretic particles 131 and the electrophoretic particles 132 are, for example, a plurality of black electrophoretic particles and a plurality of white electrophoretic particles respectively.

When the display device 1E operates in the fourth mode, at least one of the light-emitting elements may emit a light L. In addition, by applying a positive voltage to the electrode E3 and a negative voltage to the common electrode 16E, the principle of positive and negative attraction causes the white electrophoretic particles to be distributed on the display side of the display device 1E (such as the upper side of the reflectance control element 130a) and the sidewall of the reflectance control element adjacent to the light-emitting element (such as the light-emitting element 120a) so as to reflect a large-angle light from the light-emitting element and achieve the effect of collimating the light (or limiting the viewing angle or preventing peeping) or improving the light utilization efficiency. In some embodiments, the thickness of the sidewall of the reflectance control element may also be increased (for example, the reflectance control element 130a may be thickened) for the light L incident on the sidewall to be reflected by the white electrophoretic particles distributed adjacent to the sidewall of the light-emitting element (such as the light-emitting element 120a), thereby further limiting the viewing angle.

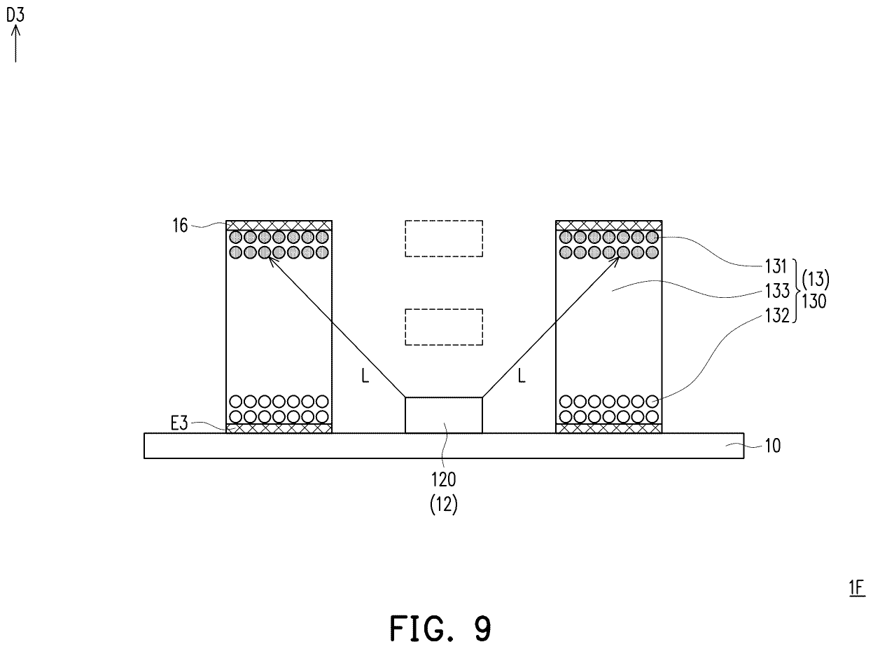

In some embodiments, the height of the light-emitting element may be adjusted and/or electrodes for driving the electrophoretic particles may be disposed according to the viewing angle specifications of the display unit 12. FIG. 9 to FIG. 14 are partial cross-sectional views of various display devices respectively according to different embodiments of the disclosure. For convenience, FIG. 9 to FIG. 14 only show the substrate, one light-emitting element of the display unit, one reflectance control element of the reflectance control unit, and a plurality of electrodes for driving the electrophoretic particles, and the other components are omitted.

Referring to FIG. 9, in a display device 1F, the height of the light-emitting element may be adjusted according to the viewing angle specifications of the display unit 12. For example, the height of the light-emitting element 120 may be changed by changing the number and/or thickness of the film layers in the circuit layer (not shown) between the light-emitting element 120 and the substrate 10, but not limited thereto.

In a mode (such as the first mode) where black electrophoretic particles (such as the electrophoretic particles 131) are distributed at the top of the reflectance control element 130 and white electrophoretic particles or colored electrophoretic particles (such as the electrophoretic particles 132) are distributed at the bottom of the reflectance control element 130, the large-angle light L from the light-emitting element 120 becomes more likely to be incident on the black electrophoretic particles and be absorbed by the black electrophoretic particles as the height of the light-emitting element 120 decreases or as the distance between the light-emitting element 120 and the substrate 10 decreases. Therefore, the viewing angle of the display unit 12 becomes narrower as the height of the light-emitting element 120 decreases or as the distance between the light-emitting element 120 and the substrate 10 decreases. That is to say, if a narrower viewing angle is desired (for preventing peeping, for example), the light-emitting element 120 may be disposed adjacent to the bottom of the reflectance control unit 13, allowing the black electrophoretic particles (such as the electrophoretic particles 131) to absorb the large-angle light L from the light-emitting element 120 to achieve the effect of limiting the viewing angle. On the contrary, if a wider viewing angle is desired (for a wide viewing angle requirement, for example), the light-emitting element 120 may be disposed adjacent to the top of the reflectance control unit 13 (the position as indicated by the dotted box in FIG. 9) to reduce the proportion of the large-angle light L from the light-emitting element 120 which is incident on the black electrophoretic particles and absorbed by the black electrophoretic particles.

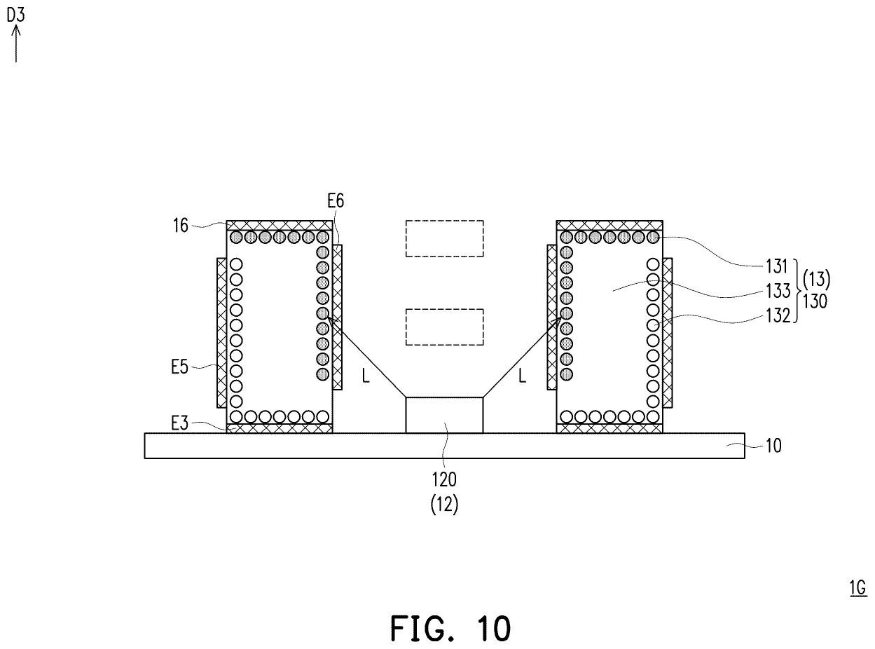

Referring to FIG. 10, in a display device 1G, the height of the light-emitting element 120 may be adjusted and electrodes for driving the electrophoretic particles may be added according to the viewing angle specifications of the display unit 12. For example, in addition to the electrode E3 and the common electrode 16, the display device 1G may further include an electrode E5 and an electrode E6, wherein the electrode E5 is disposed on a surface of the reflectance control element 130 away from the light-emitting element 120, and the electrode E6 is disposed on a surface of the reflectance control element 130 facing the light-emitting element 120. The materials of the electrode E5 and the electrode E6 may be the same as the material of the electrode E3 and will not be repeated here.

By applying a positive voltage to the common electrode 16 and the electrode E6 and a negative voltage to the electrode E3 and the electrode E5, a plurality of electrophoretic particles 131 (for example, a plurality of negatively charged black electrophoretic particles) are distributed at the top of the reflectance control element 130 and on the sidewall of the reflectance control element 130 adjacent to the light-emitting element 120, and a plurality of electrophoretic particles 132 (for example, a plurality of positively charged white electrophoretic particles or colored electrophoretic particles) are distributed at the bottom of the reflectance control element 130. The black electrophoretic particles absorb the large-angle light L from the light-emitting element 120, which helps to reduce the probability that the light L passes through the gaps between the black electrophoretic particles, thereby more effectively limiting the viewing angle. In addition, as mentioned above, the height of the light-emitting element 120 may also be adjusted according to the viewing angle specifications required, which will not be repeated here.

In some embodiments, although not shown, FIG. 10 may use the common electrode 16E as shown in FIG. 8, instead of the electrode E6. Further, although the embodiments of FIG. 9 and FIG. 10 use black electrophoretic particles to absorb the light to limit the viewing angle, the disclosure is not limited thereto. In other embodiments, the viewing angle may also be limited by using white electrophoretic particles to reflect the large-angle light L from the light-emitting element 120, as shown in the embodiments of FIG. 7 and FIG. 8, which will not be repeated here.

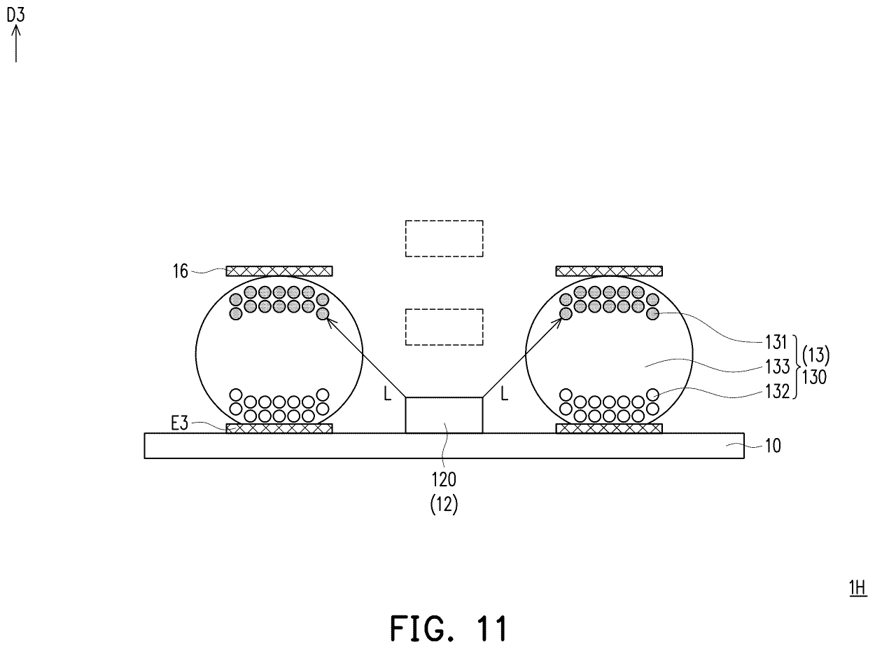

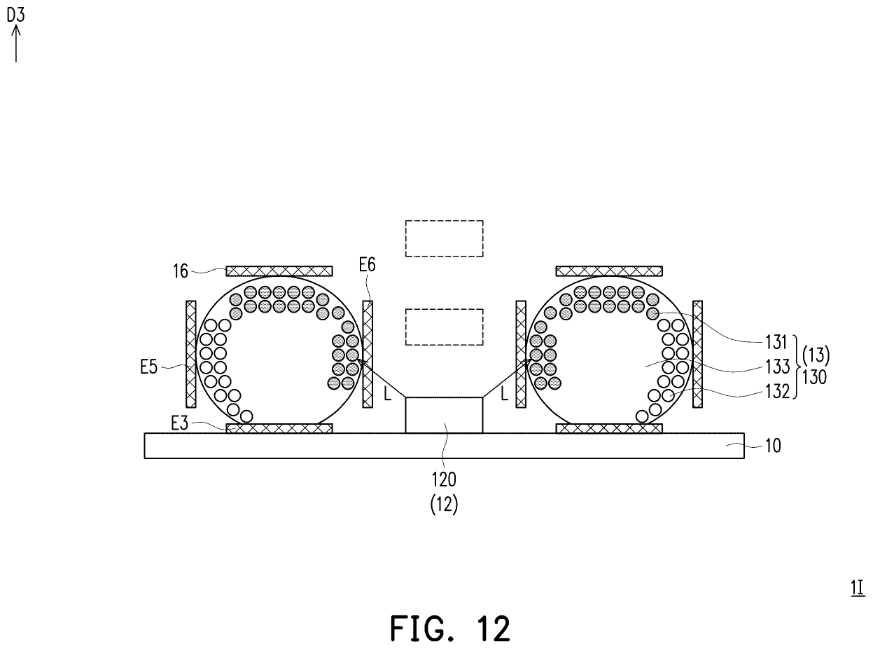

In addition, although the reflectance control element 130 of the above embodiments is exemplified in the form of microcup electrophoresis, the disclosure is not limited thereto. In other embodiments, as shown in the display device 1H of FIG. 11 and the display device 1I of FIG. 12, the reflectance control element 130 may also be in the form of microcapsule.

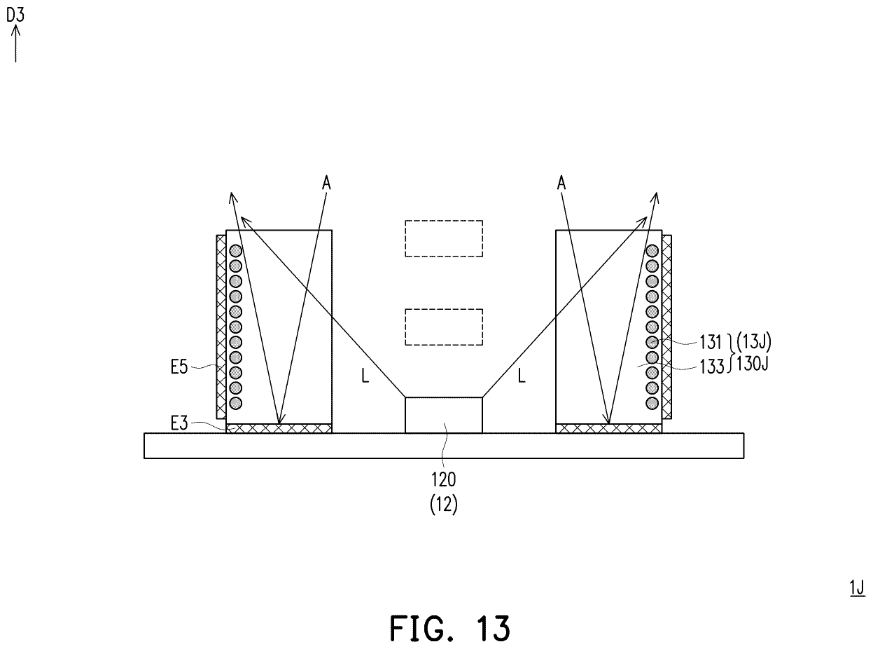

Referring to FIG. 13, in a reflectance control unit 13J of the display device 1J, a reflectance control element 130J may include a plurality of electrophoretic particles 131 (such as a plurality of black electrophoretic particles) and a solution 133 (such as a transparent solution). Further, the electrode E3 and the electrode E5 may be respectively provided at the bottom of the reflectance control element 130J and on the sidewall of the reflectance control element 130J away from the light-emitting element 120. The electrode E3 is, for example, a reflective electrode (such as an electrode made of metal, alloy, or a combination of the aforementioned).

By applying a positive voltage to the electrode E5, a plurality of electrophoretic particles 131 (for example, a plurality of negatively charged black electrophoretic particles) are distributed on the sidewall of the reflectance control element 130J away from the light-emitting element 120, which reduces the shielding of the black electrophoretic particles for the ambient light A or the large-angle light L from the light-emitting element 120 (that is, achieve a wide viewing angle), and the ambient light A incident on the reflectance control element 130J is reflected through the electrode E3. Furthermore, when the reflectance control unit 13J is to provide a black screen, no voltage is applied to the electrode E5 and/or a positive voltage is applied to the electrode E3, so that a plurality of electrophoretic particles 131 are distributed at the bottom of the reflectance control element 130J to absorb the ambient light A incident on the reflectance control element 130J.

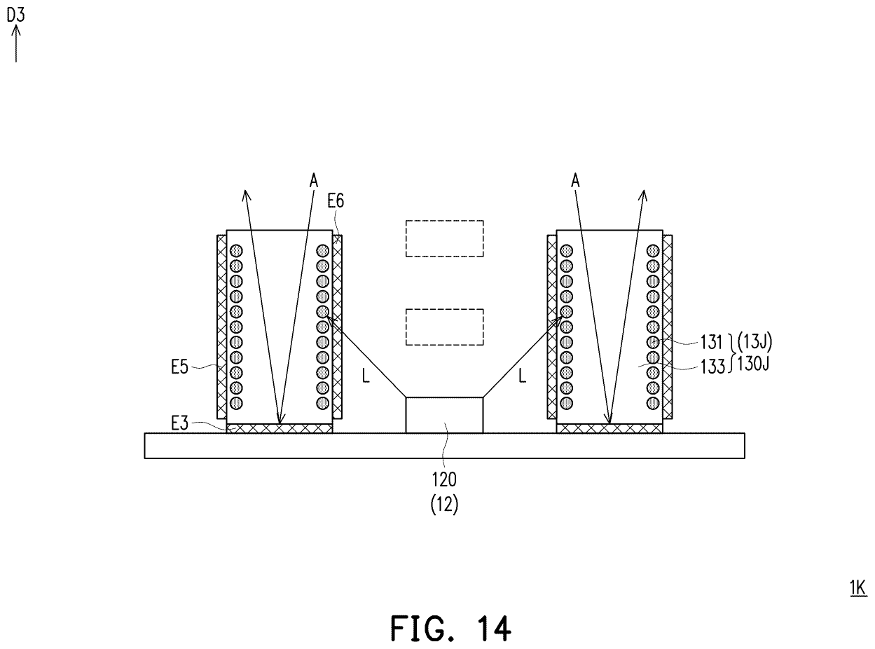

Referring to FIG. 14, a display device 1K may further include an electrode E6 disposed on the sidewall of the reflectance control element 130J facing the light-emitting element 120. By applying a positive voltage to the electrode E5 and the electrode E6, a plurality of electrophoretic particles 131 (for example, a plurality of negatively charged black electrophoretic particles) are distributed on the sidewall of the reflectance control element 130J away from the light-emitting element 120 and on the sidewall facing the light-emitting element 120 to absorb the large-angle light L from the light-emitting element 120 and the large-angle ambient light A incident on the reflectance control element 130J, thereby achieving the effect of limiting the viewing angle, and the ambient light A incident on the reflectance control element 130J is reflected through the electrode E3.

Furthermore, when the reflectance control unit 13J is to provide a black screen, no voltage is applied to the electrode E5 and the electrode E6, and/or a positive voltage is applied to the electrode E3, so that a plurality of electrophoretic particles 131 are distributed at the bottom of the reflectance control element 130J to absorb the ambient light A incident on the reflectance control element 130J.

In some embodiments, although not shown, a plurality of transparent micro-bumps may be disposed on the electrode E3 in FIG. 13 and FIG. 14 to provide an anti-glare effect. In other embodiments, although not shown, a highly reflective layer may be formed on a plurality of transparent micro-bumps to utilize light scattering/diffraction to increase the intensity of reflected light.

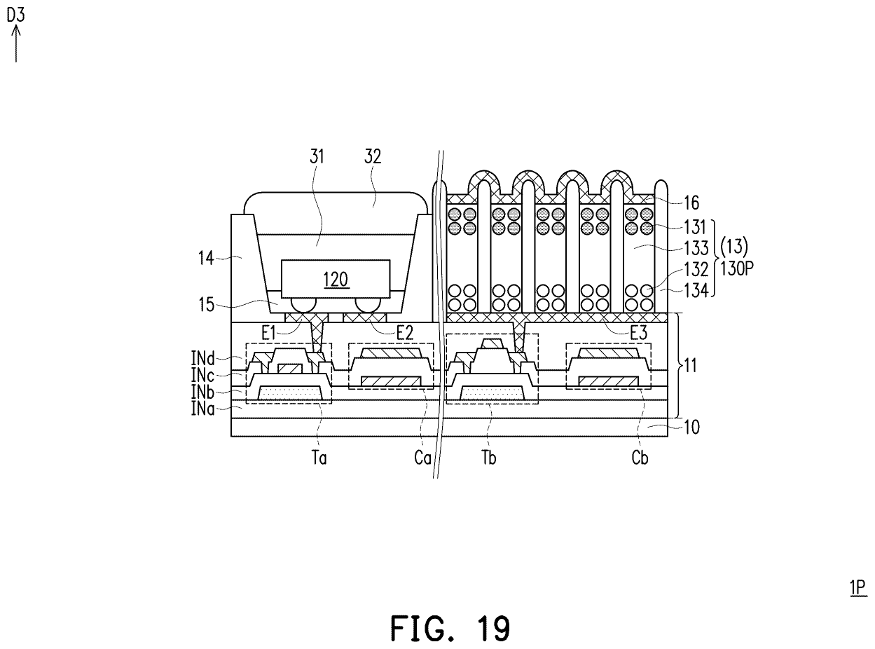

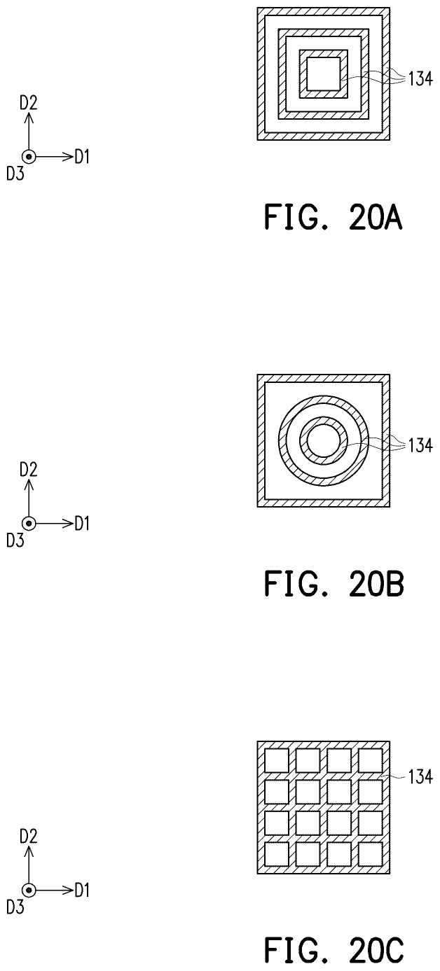

FIG. 15 to FIG. 19 are partial cross-sectional views of various display devices respectively according to different embodiments of the disclosure. FIG. 20A to FIG. 20C are various partial top views of the reflectance control unit in FIG. 19 respectively.

Referring to FIG. 15, the main differences between a display device 1L and the aforementioned display devices will be described hereinafter. In the display device 1L, a light-emitting element 120′ is, for example, a vertical light-emitting element. That is, two electrodes of the light-emitting element 120′ are respectively located on the upper and lower sides of a semiconductor substrate. Under this architecture, the display unit 12 and the reflectance control unit 13 may be electrically connected to the same common electrode (such as the common electrode 16), and the electrode E2 in FIG. 2A may be omitted from the circuit layer 11L. The display device 1L may further include an interposer layer 18 (for example, a filling layer, and the material may be the same as the material of the interposer layer 15). The interposer layer 18 is disposed on the light-emitting element 120′ and the interposer layer 15, and the common electrode 16 may be disposed on the interposer layer 18 and the reflectance control element 130, wherein the common electrode 16 may penetrate the interposer layer 18 and be electrically connected to the light-emitting element 120′. The common electrode 16 is, for example, a transparent electrode to facilitate the light L emitted from the light-emitting element 120′ to exit from above the display device 1L, but the disclosure is not limited thereto.

The display device 1L may further include a peripheral circuit 19, and the common electrode 16 may be electrically connected to the circuit layer 11L through the peripheral circuit 19. In some embodiments, the display unit 12 and the reflectance control unit 13 may be electrically connected to different driving units, and the different driving units may be provided on different circuit carrier boards. For example, the display device 1L may further include a connection circuit 20, a connection circuit 21, a driving unit 22, a driving unit 23, a circuit carrier board 24, and a circuit carrier board 25. The connection circuit 20 may electrically connect the circuit layer 11L and the circuit carrier board 24. The driving unit 22 is disposed on the lower surface of the circuit carrier board 24, and the connection circuit 20 may be electrically connected to the driving unit 22 through the circuit carrier board 24. Similarly, the connection circuit 21 may electrically connect the circuit layer 11L and the circuit carrier board 25. The driving unit 23 is disposed on the lower surface of the circuit carrier board 25, and the connection circuit 21 may be electrically connected to the driving unit 23 through the circuit carrier board 25. The connection circuits 20 and 21 are, for example, flexible printed circuit boards. The driving units 22 and 23 are, for example, driving chips. The circuit carrier boards 24 and 25 are, for example, printed circuit boards.

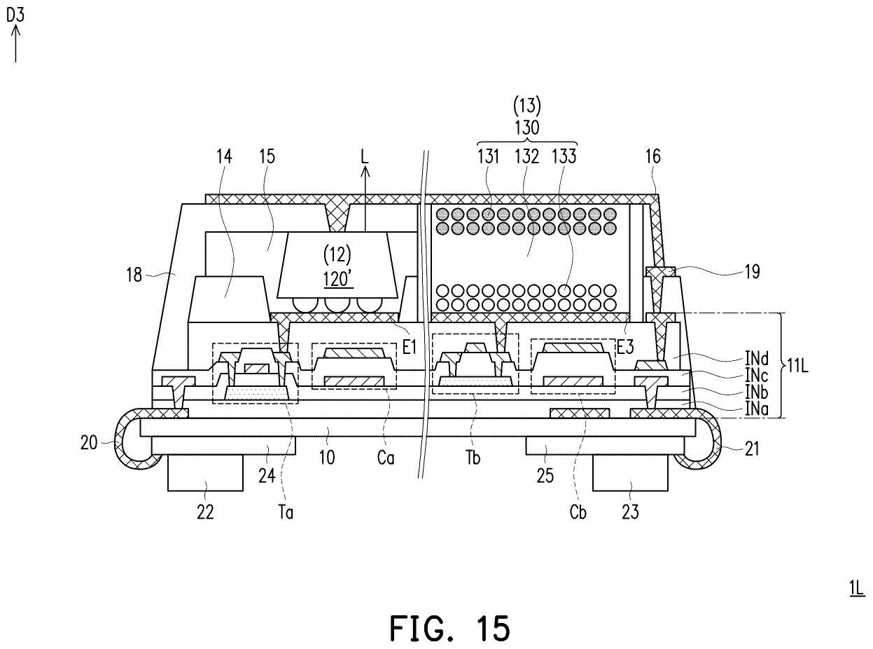

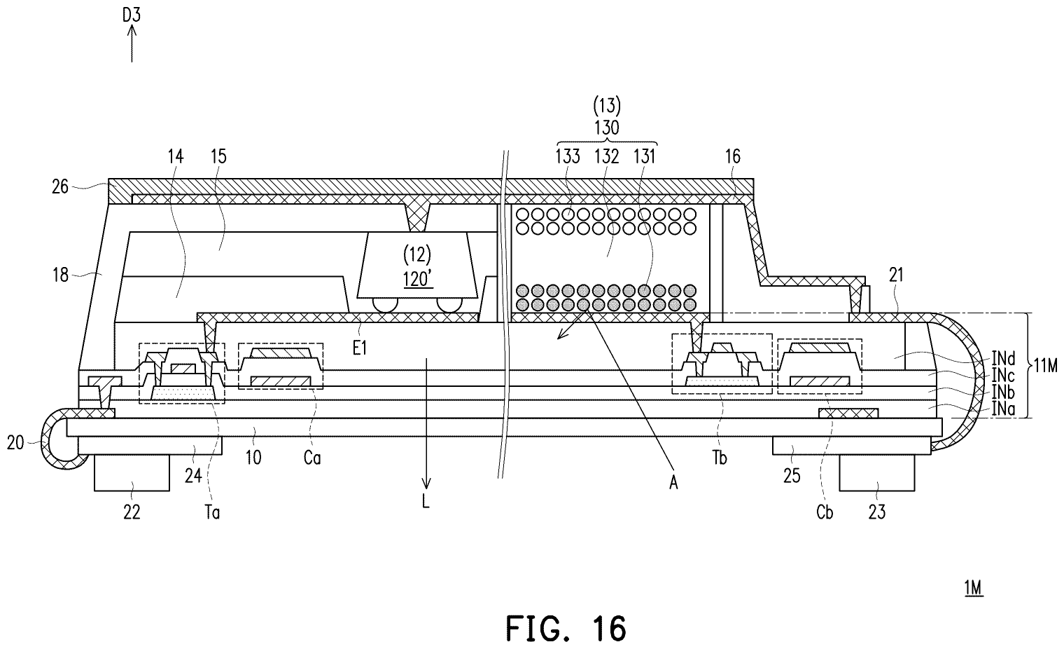

Referring to FIG. 16, the main differences between a display device 1M and the display device 1L of FIG. 15 will be described hereinafter. The display device 1M is, for example, a bottom-emission display device. The display device 1M further includes an electrode 26. The electrode 26 is disposed on the interposer layer 18 and the common electrode 16, and the electrode 26 is, for example, a reflective electrode. The material of the electrode 26 includes, for example, metal, alloy, or a combination of the aforementioned. In some embodiments, the common electrode 16 may also serve as a reflective electrode. In a circuit layer 11M, the light-shielding elements (such as transistors and storage capacitors) may be staggered from the display unit 12 and the reflectance control unit 13 in the direction D3. That is, the area where the light-shielding elements overlap the display unit 12 and the reflectance control unit 13 in the direction D3 is reduced to suppress the light-shielding elements from shielding the light L emitted by the light-emitting element 120′ and the ambient light A.

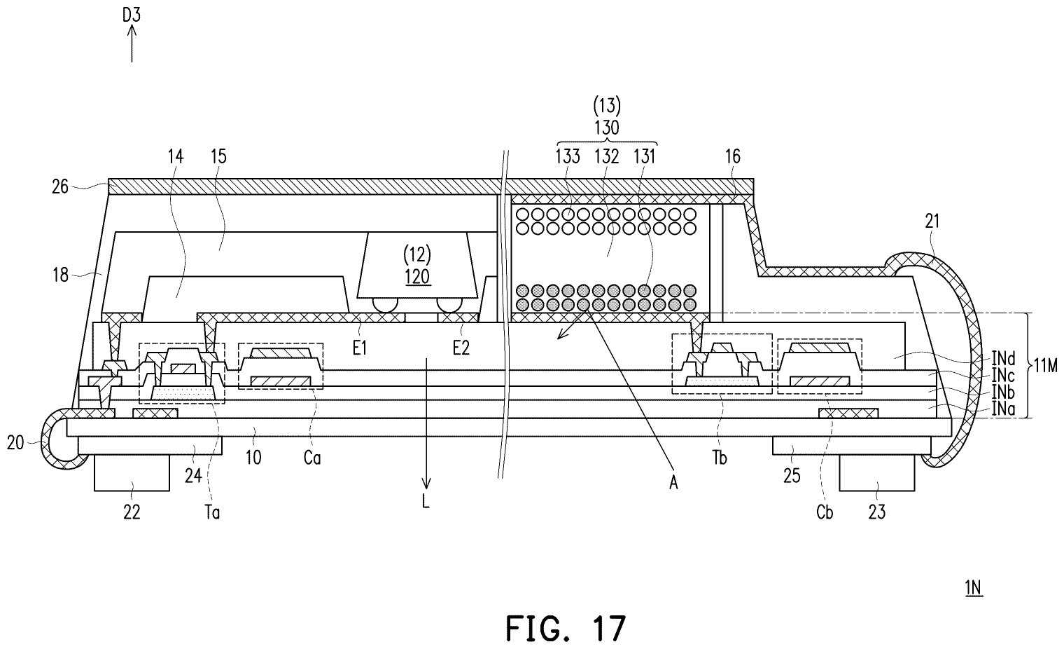

Referring to FIG. 17, the main differences between a display device IN and the display device 1M of FIG. 16 will be described hereinafter. In the display device IN, the light-emitting element 120 is, for example, a horizontal light-emitting element. That is, the two electrodes of the light-emitting element 120 are respectively located on the same side of the semiconductor substrate. Under this architecture, the display unit 12 and the reflectance control unit 13 may be electrically connected to different common electrodes. For example, the display unit 12 may be electrically connected to the electrode E2 (serving as a common electrode), and the reflectance control unit 13 may be electrically connected to the common electrode 16. Under this architecture, the common electrode 16 may not overlap the display unit 12 in the direction D3, and the common electrode 16 is electrically insulated from the light-emitting element 120.

In some embodiments, although not shown, the light-emitting element 120′ in the embodiment of FIG. 15 may be a horizontal light-emitting element. Under this architecture, the display unit 12 and the reflectance control unit 13 may be electrically connected to different common electrodes. The common electrode 16 is electrically insulated from the light-emitting element and may not overlap the display unit 12 in the direction D3. Thus, a display device using the horizontal light-emitting element may also be a top-emission display device.

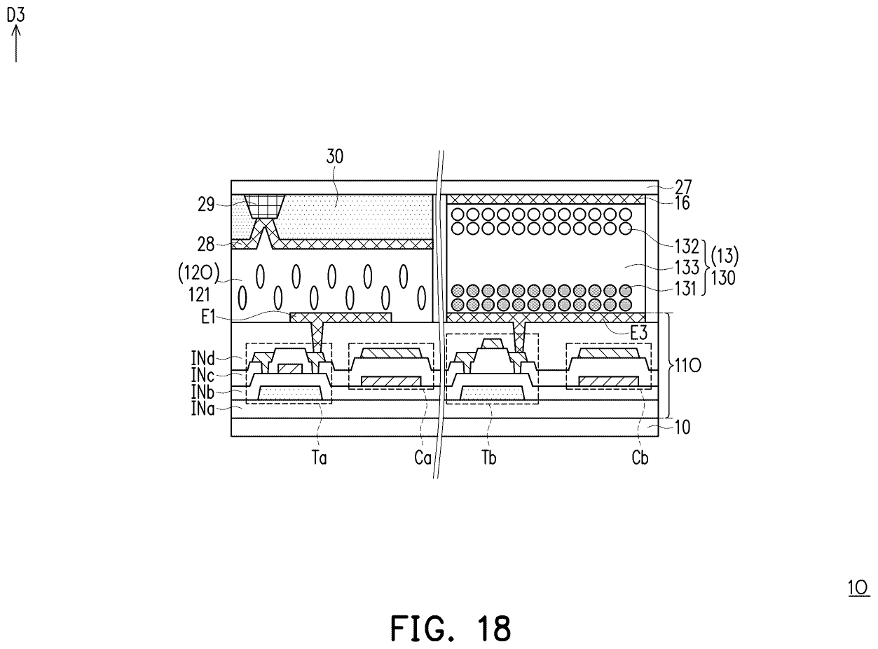

Referring to FIG. 18, the main differences between a display device 1O and the aforementioned display device will be described hereinafter. In the display device 1O, a display unit 120 is a non-self-luminous display unit. For example, the display unit 120 is a liquid crystal display unit and includes a liquid crystal layer 121. The display device 1O may further include a substrate 27 disposed opposite to the substrate 10. The material of the substrate 27 may be understood from the description of the material of the substrate 10 and will not be repeated here. In addition, the display device 1O may further include a common electrode 28, a black matrix 29, and a filter layer 30, wherein the common electrode 28 is a light-transmissive electrode, and the common electrode 28 and the electrode E1 are respectively located on opposite sides of the liquid crystal layer 121. The black matrix 29 is disposed on a surface of the substrate 27 facing the liquid crystal layer 121 and is located between the common electrode 28 and the substrate 27. The filter layer 30 may include a plurality of filter patterns (not labeled), and the filter patterns are respectively located in a plurality of openings (not labeled) of the black matrix 29.

Referring to FIG. 19, the main differences between a display device 1P and the aforementioned display device will be described hereinafter. In the display device 1P, the interposer layer 15 does not completely cover the light-emitting element 120. In addition, the display device 1P further includes a color conversion layer 31 and an anti-reflection layer 32, wherein the color conversion layer 31 is disposed on the interposer layer 15 and covers the light-emitting element 120, and the anti-reflection layer 32 is disposed on the color conversion layer 31. The material of the color conversion layer 31 includes, for example, fluorescence, phosphor, quantum dot (QD), other suitable materials, or a combination of the aforementioned materials, but not limited thereto. The anti-reflection layer 32 may include a plurality of low refractive index dielectric layers and a plurality of high refractive index dielectric layers alternately stacked in the direction D3.

In addition to a plurality of electrophoretic particles 131, a plurality of electrophoretic particles 132, and a solution 133, the reflectance control element 130P may further include a plurality of reflective bumps 134. The reflective bumps 134 may increase the reflective area/angle. In some embodiments, a plurality of reflectance control elements 130P in the reflectance control unit 13 may have different top-view patterns to reduce moiré patterns. For example, as shown in FIG. 20A, the top-view patterns of the reflective bumps 134 may include a plurality of annular rectangles, and the annular rectangles may be concentric, but not limited thereto. As shown in FIG. 20B, the top-view patterns of the reflective bumps 134 may include a plurality of circular rings and an annular rectangle, and the circular rings and the annular rectangle may be concentric, but not limited thereto. As shown in FIG. 20C, the top-view patterns of the reflective bumps 134 may include a grid shape composed of a plurality of vertical bars extending in the direction D1 and a plurality of horizontal bars extending in the direction D2, but not limited thereto. In other embodiments, although not shown, the top-view patterns of the reflective bumps 134 may include a pattern composed of an annular rectangle and a plurality of straight bars extending in the direction D1 or a pattern composed of an annular rectangle and a plurality of straight bars extending in the direction D2, but not limited thereto.

To sum up, in one or more embodiments of the disclosure, the display unit and the reflectance control unit are disposed on the same side of the substrate, making it possible to provide multiple display modes on the same side of the display device. In addition, the state of the reflectance control unit (for example, the distribution of electrophoretic particles) is electronically controlled so as to control the viewing angle without an external viewing angle optical film.

The above embodiments merely serve to illustrate, but not to limit, the technical solutions of the disclosure. Although the disclosure has been described in detail with reference to the above embodiments, those skilled in the art should understand that the technical solutions described in the above embodiments can still be modified or some or all of the technical features thereof can be equivalently replaced. However, the modifications or replacements do not cause the essence of the corresponding technical solutions to deviate from the scope of the technical solutions of the embodiments of the disclosure.

Although the embodiments of the disclosure and the advantages thereof have been disclosed above, it should be understood that any person skilled in the art can make changes, substitutions, and modifications without departing from the spirit and scope of the disclosure, and the features of the embodiments can be arbitrarily mixed and replaced to form other new embodiments. In addition, the protection scope of the disclosure is not limited to the process, machine, manufacture, material composition, device, method, and steps in the specific embodiments described in the specification. Any person skilled in the art can understand conventional or future-developed processes, machines, manufactures, material compositions, devices, methods, and steps from the content of the disclosure as long as the same can implement substantially the same functions or achieve substantially the same results in the embodiments described herein. Therefore, the protection scope of the disclosure includes the above processes, machines, manufactures, material compositions, devices, methods, and steps. In addition, each claim constitutes a separate embodiment, and the protection scope of the disclosure further includes combinations of the claims and the embodiments. The protection scope of the disclosure should be defined by the appended claims.

What is claimed is:

1. A display device, comprising:
a substrate;
a circuit layer disposed on the substrate;
a display unit disposed on the substrate and electrically connected to the circuit layer; and
a reflectance control unit disposed on the substrate and electrically connected to the circuit layer,
wherein the display unit and the reflectance control unit are disposed on a same side of the substrate.

2. The display device according to claim 1, wherein the display unit and the reflectance control unit are configured to display a first image and a second image respectively toward a same direction.

3. The display device according to claim 2, wherein the display device is capable of operating in a first mode and a second mode, wherein the display unit displays the first image in response to the display device operating in the first mode, and the reflectance control unit displays the second image in response to the display device operating in the second mode.

4. The display device according to claim 3, wherein the reflectance control unit absorbs an ambient light in response to the display device operating in the first mode.

5. The display device according to claim 3, wherein the display unit is turned off in response to the display device operating in the second mode.

6. The display device according to claim 3, wherein the reflectance control unit comprises a plurality of reflectance control elements, wherein in response to the display device operating in the second mode, a part of the reflectance control elements reflects a light and another part of the reflectance control elements absorbs an ambient light.

7. The display device according to claim 3, wherein the reflectance control unit comprises a plurality of reflectance control elements, wherein in response to the display device operating in the second mode, a first part of the reflectance control elements reflects a first light, a second part of the reflectance control elements reflects a second light, and the first light and the second light are different in color.

8. The display device according to claim 1, wherein the display device is capable of operating in a first mode, a second mode, and a third mode, wherein the display unit displays a first image in response to the display device operating in the first mode, the reflectance control unit displays a second image in response to the display device operating in the second mode, and the display unit and the reflectance control unit display different images in response to the display device operating in the third mode.

9. The display device according to claim 1, wherein the display device is capable of operating in a fourth mode, wherein in response to the display device operating in the fourth mode, the display unit displays a third image and the reflectance control unit reflects a light from the display unit.

10. The display device according to claim 1, wherein the display unit and the reflectance control unit are electrically connected to a same common electrode.

11. The display device according to claim 1, wherein the display unit and the reflectance control unit are electrically connected to different common electrodes.

12. The display device according to claim 1, wherein the display unit comprises a plurality of light-emitting elements, the reflectance control unit comprises a plurality of reflectance control elements, and at least one of the light-emitting elements is surrounded by one of the reflectance control elements in a top view.

13. The display device according to claim 1, wherein the display unit comprises a plurality of light-emitting elements, the reflectance control unit comprises a plurality of reflectance control elements, and a resolution of the light-emitting elements is equal to or greater than a resolution of the reflectance control elements.

14. The display device according to claim 1, wherein an area occupied by the display unit is smaller than an area occupied by the reflectance control unit in a top view.

15. The display device according to claim 1, wherein the reflectance control unit comprises a plurality of reflectance control elements, and each of the reflectance control elements comprises a plurality of electrophoretic particles.

16. The display device according to claim 15, wherein each of the reflectance control elements comprises a plurality of black electrophoretic particles and a plurality of white electrophoretic particles.

17. The display device according to claim 15, wherein each of the reflectance control elements comprises a plurality of black electrophoretic particles and a plurality of colored electrophoretic particles.

18. The display device according to claim 1, wherein the circuit layer comprises:
a first-type transistor electrically connected to the display unit; and
a second-type transistor electrically connected to the reflectance control unit.

19. The display device according to claim 18, wherein the first-type transistor comprises a silicon semiconductor, and the second-type transistor comprises an oxide semiconductor.

20. The display device according to claim 18, wherein the first-type transistor has a first channel width and a first channel length, the second-type transistor has a second channel width and a second channel length, and a ratio of the first channel width to the first channel length is smaller than a ratio of the second channel width to the second channel length.
